(19) United States
(12) Patent Application Publication
(10) Pub. No.: US 2007/0184418 A1
(43) Pub. Date: Aug. 9, 2007

(54) Method for computer-assisted learning

(76) Inventor: Yi-Ming Tseng, Palo Alto, CA (US)

Correspondence Address: YI-MING TSENG, P.O. BOX 19428, STANFORD, CA, 94309-9428, US

(21) Appl. No.: 11/348,890

(22) Filed: Feb. 7, 2006

(51) Int. Cl. G09B 19/00

(52) U.S. Cl. 434/156

(57) ABSTRACT

One embodiment of the present invention is a method for learning an object including: (a) receiving a selected content type that is selected from a plurality of content types; (b) providing a content that is consistent with the selected content type and comprises information relating to the object; and (c) providing a game that includes the content and the object.

### TECHNICAL FIELD OF THE INVENTION

One or more embodiments of the present invention relate to a method for assisting learning, and more particularly, a method for computer-assisted learning.

### BACKGROUND OF THE INVENTION

Conventionally, a computer-assisted learning system or method provider would try to assist learning through most advance technology and richest contents that the provider has access to. Nowadays, computer-assisted learning is usually provided through multimedia technology with multimedia contents. However, such a richest-content approach may not meet a user's various learning needs in a most effective and efficient way. For example, when the user needs to learn a language for use in everyday conversations, multimedia contents that simulate scenarios of conversations should be helpful; however, when the user needs to learn the language for use in translation, multimedia contents may not be as effective and efficient as text-only contents. For example, the multimedia contents may provide unnecessary information or require more time for the user to comprehend. The user may adopt different computer-assisted learning systems or methods for different contents to satisfy different learning needs. Nevertheless, the more systems or methods that the user adopt, the more time and other resources the user needs to spend in learning and using the systems or method and maintaining and managing user data.

In light of the above, there is a need in the art for a method or apparatus that solves one or more of the above-identified problems.

### SUMMARY OF THE INVENTION

One or more embodiments of the present invention solve one or more of the above-identified problems. In particular, one embodiment of the present invention is a method for assisting learning an object including: (a) receiving a selected content type that is selected from a plurality of content types; (b) providing a content that is consistent with the selected content type and comprises information relating to the object; and (c) providing a game that includes the content and the object. In accordance with one or more embodiments of the present invention, learning means learning, re-learning, or reviewing.

### BRIEF DESCRIPTION OF THE DRAWING

FIG. 1 shows a system for assisting learning that is fabricated in accordance with one or more embodiments of the present invention;

FIG. 2 is a flowchart of a method that is fabricated in accordance with one or more embodiments of the present invention (which, for example and without limitation, utilizes the system shown in FIG. 1) for assisting learning;

FIG. 3 is a flowchart of a method that is fabricated in accordance with one or more embodiments of the present invention (which, for example and without limitation, utilizes the system shown in FIG. 1) for assisting learning;

FIGS. 4A-4D illustrate user interfaces that are fabricated in accordance with one or more embodiments of the present invention for object, content, language, and game selections;

FIG. 5 illustrates a set of contents that is fabricated in accordance with one or more embodiments of the present invention;

FIG. 6 illustrates a multiple choice game that is fabricated in accordance with one or more embodiments of the present invention;

FIG. 7 illustrates a matching game that is fabricated in accordance with one or more embodiments of the present invention; and

FIGS. 8A-8F illustrate a memory matching game that is fabricated in accordance with one or more embodiments of the present invention.

### DETAILED DESCRIPTION

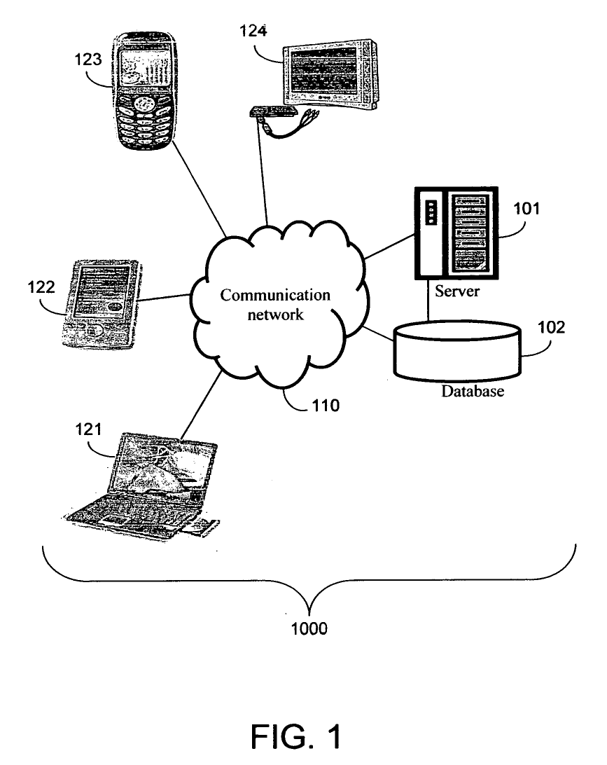

FIG. 1 shows computer-assisted learning system 1000 that is fabricated in accordance with one or more embodiments of the present invention. As shown in FIG. 1, computer-assisted learning system 1000 includes: (a) communication network 110; (b) database 102; and (c) server 101 that is connected to communication network 110 and database 102 and is adapted to: (i) receive inputs from communication network 110; (ii) update database 102 with the inputs; (iii) retrieve data from database 102; (iv) provide contents using the inputs and the data; and (iv) send the contents through communication network 110. In accordance with one or more such invention, computer-assisted learning system 1000 further includes one or more clients or user devices such as, for example and without limitation, computer 121, personal digital assistant 122, cellular phone 123, and television 124 that connect to communication network 110.

Conventional hardware and software components, communication protocols, and data formats may be used in computer-assisted learning system 1000 for communication network 110, database 102, server 101, and clients 121-124. In accordance with one or more embodiments of the present invention, communication network 110 includes a data network. In accordance with one or more embodiments of the present invention, communication network includes a mobile communication network. In accordance with one or more embodiments of the present invention, server 101 includes a Web server that runs a server program that is well known to one of ordinary skill in the art such as, for example and without limitation, Apache HTTP Server from The Apache Software Foundation (www.apache.org). In accordance with one or more embodiments of the present invention, server 101 is adapted to provide mobile Internet access based on an industry standard such as, for example and without limitation, Wireless Application Protocol (WAP). In accordance with one or more embodiments of the present invention, database 102 runs a database management system (DBMS) that is well known to one of ordinary skill in the art such as, for example and without limitation, MySQL from MySQL AB (www.mysql.com). In accordance with one or more embodiments of the present invention, clients 121-124 runs a Web browser such as, for example and without limitation, Microsoft Internet Explorer from Microsoft Corporation (www.microsoft.com) or a mobile or wireless Internet browser such as, for example and without limitation, Openwave Mobile Browser from Openwave Systems Inc. (www.openwave.com).

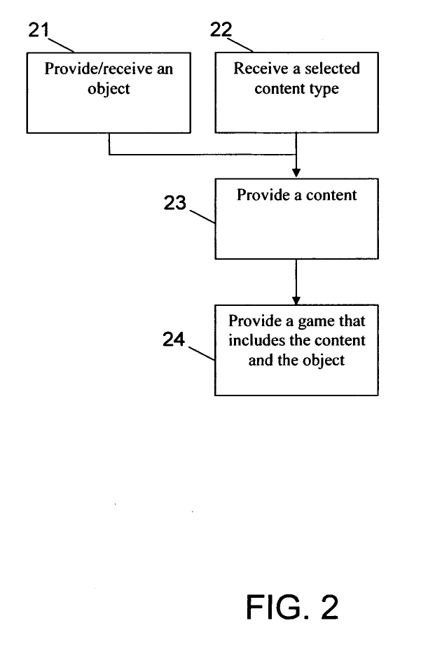

FIG. 2 is a flowchart of a method that is fabricated in accordance with one or more embodiments of the present invention (which, for example and without limitation, utilizes computer-assisted learning system 1000 shown in FIG. 1) for assisting learning an object. The method includes: (a) receiving a selected content type that is selected from a plurality of content types; (b) providing a content that is consistent with the selected content type and comprises information relating to the object; and (c) providing a game that includes the content and the object. In accordance with one or ore embodiments of the present invention, learning means learning, re-learning, or reviewing. In accordance with one or more embodiments of the present invention, the method is implemented using one or more computer programming languages that are well known to one of ordinary skill in the art such as, for example and without limitation, PHP from The PHP Group (www.php.net).

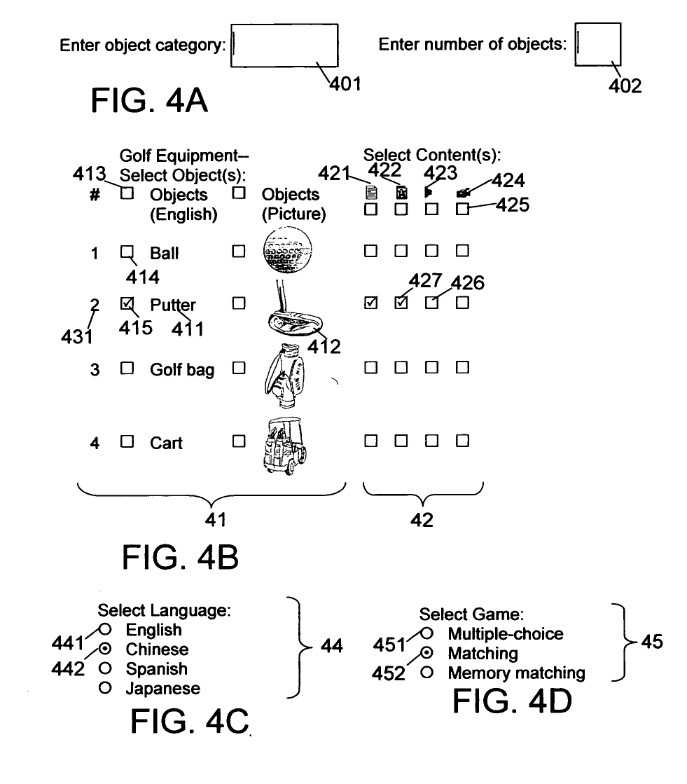

In the method, at step 21 (shown in FIG. 2), server 101 (shown in FIG. 1) (i) provides an object to be learned or (ii) receives an object to be learned through communication network 110 (shown in FIG. 1) that a user inputs or selects by using a user device such as, for example and without limitation, one of clients 121-124 (shown in FIG. 1). In accordance with one or more embodiments of the present invention, server 101 provides the object in a text, picture, audio, or multimedia format that is well known in the art. In accordance with one or more embodiments of the present invention, server 101 provides the object based on user data such as, for example and without limitation, interests of objects, content type preferences, or past learning performance. In accordance with one or more embodiments of the present invention, server 101 provides a user interface for the user to input or select the object that is well known in the art such as, for example and without limitation, a text box, combo box, or menu. In accordance with one or more such embodiments, the menu includes a pull-down menu. In accordance with one or more embodiments of the present invention, the menu includes a set of images that the user can click on to select or unselect objects. In accordance with one or more embodiments of the present invention, the menu includes check boxes (such as check box 414 shown in FIG. 4B) or radio buttons for the user to select or unselect objects.

At step 22 (shown in FIG. 2), server 101 (shown in FIG. 1) receives a selected content type through communication network 110 (shown in FIG. 1) that the user selects from a plurality of content types using a user device such as, for example and without limitation, one of clients 121-124 (shown in FIG. 1). In accordance with one or more embodiments of the present invention, the plurality of content types includes a text type. In accordance with one or more embodiments of the present invention, the plurality of content types includes a picture type. In accordance with one or more embodiments of the present invention, the plurality of content types includes an audio type. In accordance with one or more embodiments of the present invention, the plurality of content types includes a multimedia type. In accordance with one or more embodiments of the present invention, server 101 provides a user interface for the user to select from the plurality of content types that is well known in the art such- as; for example and without limitation, a combo box or menu. In accordance with one or more such embodiments, the menu includes a pull-down menu. In accordance with one or more embodiments of the present invention, the menu includes a set of images that the user can click on to select or unselect a content type. In accordance with one or more embodiments of the present invention, the menu includes check boxes (such as check box 426 shown in FIG. 4B) or radio buttons for the user to select or unselect content types. Then, control is transferred to step 23 (shown in FIG. 2).

At step 23 (shown in FIG. 2), server 101 (shown in FIG. 1) provides a content that is consistent with the selected content type and comprises information relating to the object. In accordance with one or more embodiments of the present invention, server 101 (shown in FIG. 1) provides the content using data in database 102 (shown in FIG. 1). In accordance with one or more embodiments of the present invention, the content comprises a translation, synonym, definition, description, detail, reference, or clue of the object. In accordance with one or more embodiments of the present invention, the content comprises an illustration, detail, reference, subsystem, super-system, or clue of the object. A content that is consistent with the text type may include a symbol, character, word, phrase, sentence, or passage. A content that is consistent with the picture type may include a drawing, a still image, an animation, or a video recording. A content that is consistent with the audio type may include a sound or a recorded reading or narration of a symbol, character, word, phrase, sentence, or passage. A content that is consistent with the multimedia type may be consistent with two or more of text, picture, and audio types. Then, control is transferred to step 24 (shown in FIG. 2).

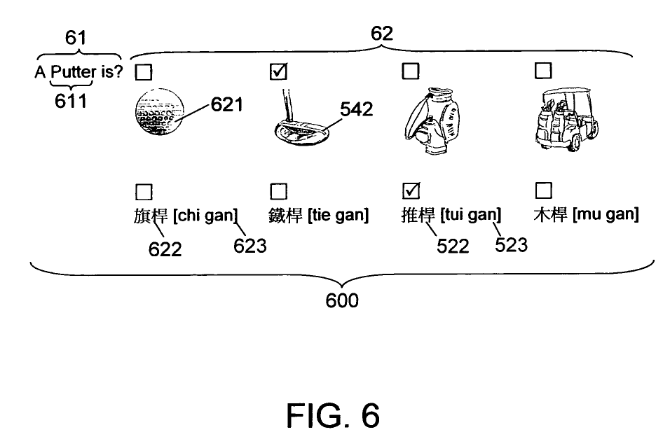

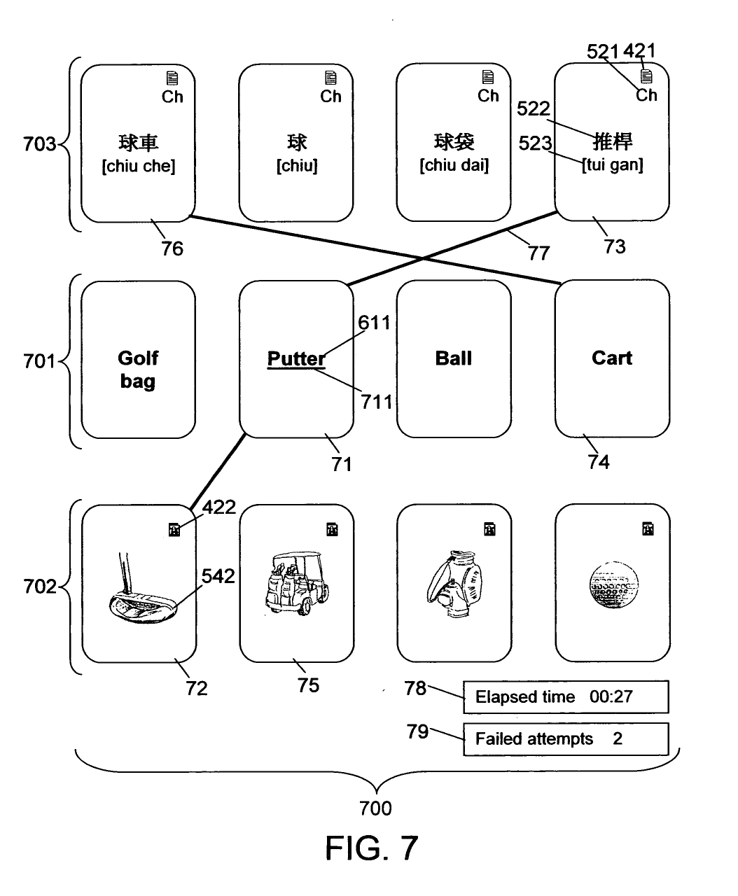

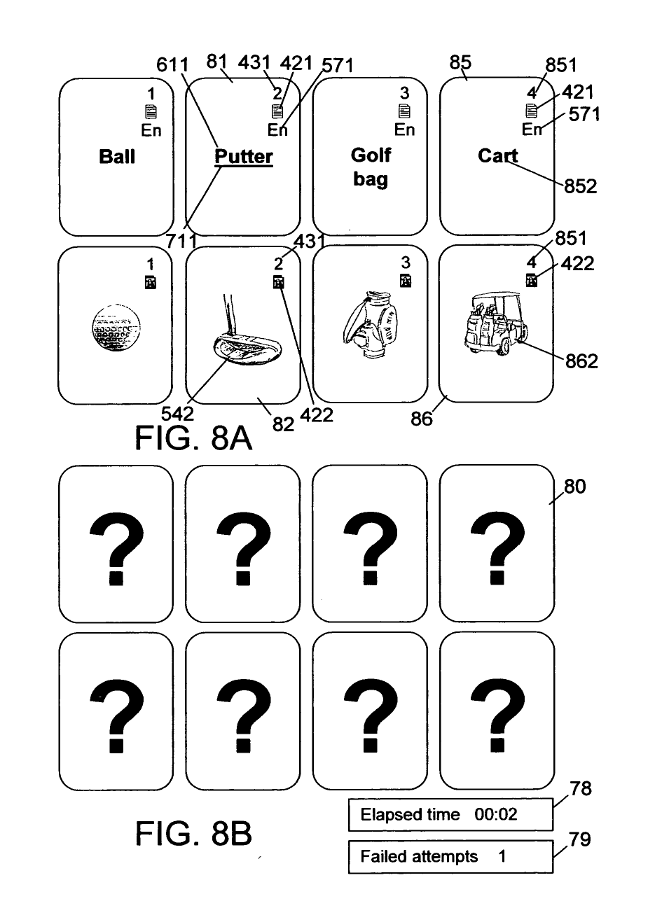

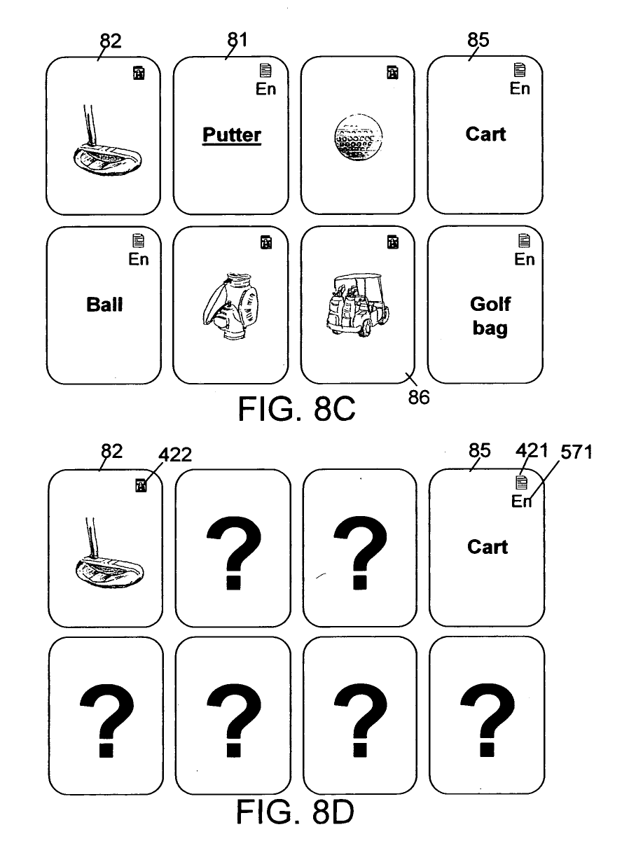

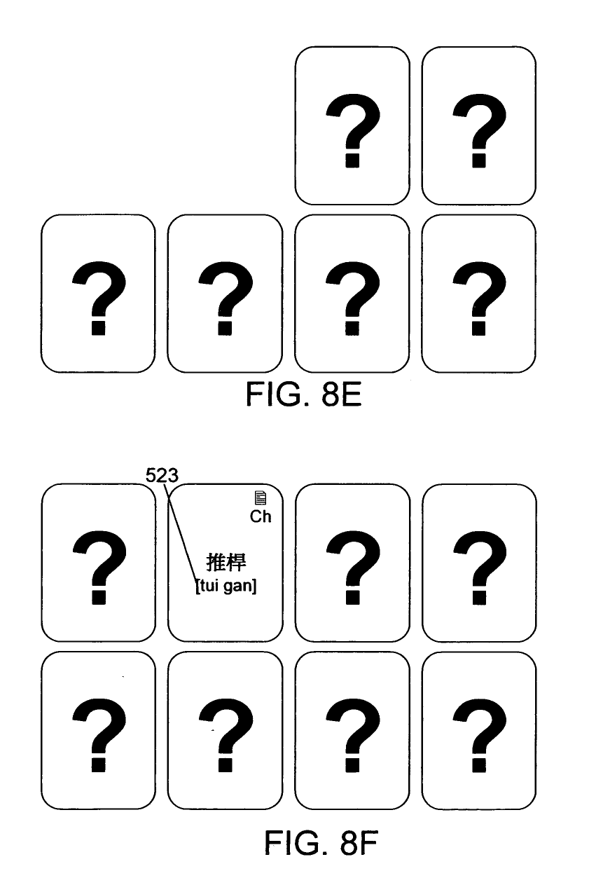

At step 24 (shown in FIG. 2), server 101 (shown in FIG. 1) provides a game that includes the content provided at step 23 (shown in FIG. 2) and the object provided or received by server 101 (shown in FIG. 1) at step 21 (shown in FIG. 2). In accordance with one or more embodiments of the present invention, the game includes the object in a multiple choice question and includes the content as a choice of the multiple choice question (as will be illustrated below with reference to FIG. 6). In accordance with one or more embodiments of the present invention, the game includes a matching game that allows a player to match the object and the content (as will be illustrated below with reference to FIG. 7). In accordance with one or more embodiments of the present invention, the game includes a memory matching game that allows a player to match the object and the content (as will be illustrated below with reference to FIGS. 8A-8F).

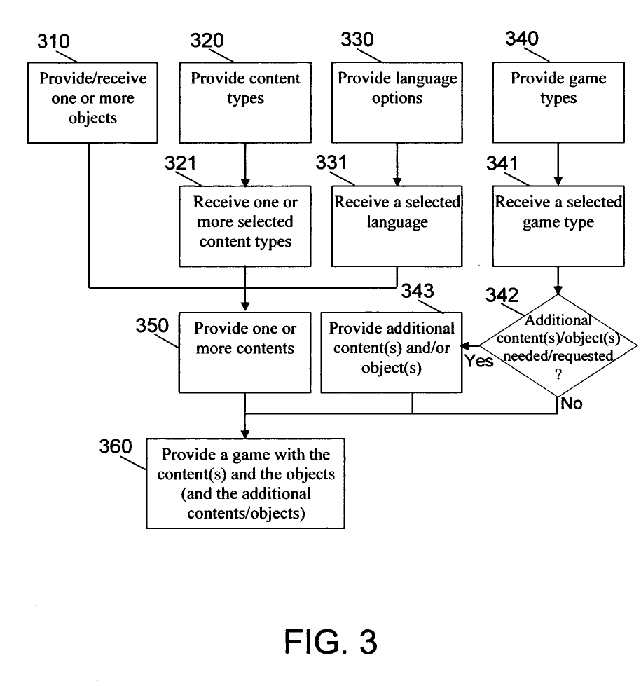

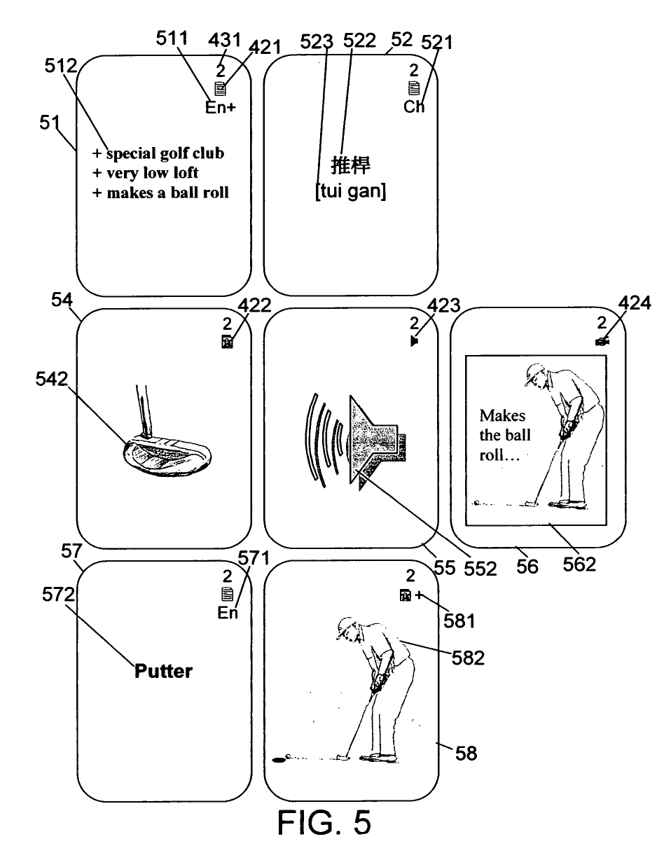

FIG. 3 is a flowchart of a method that is fabricated in accordance with one or more embodiments of the present invention (which, for example and without limitation, utilizes computer-assisted learning system 1000 shown in FIG. 1) for assisting learning one or more objects. FIGS. 4A-4D illustrate user interfaces that are fabricated in accordance with one or more embodiments of the present invention for object, content, language, and game selections in the method. FIG. 5 illustrates contents that are fabricated in accordance with one or more embodiments of the present invention for use in the method.

In the method shown in FIG. 3, at step 310 (shown in FIG. 3), server 101 (shown in FIG. 1) (i) provides one or more objects to be learned or (ii) receives one or more objects to be learned through communication network 110 (shown in FIG. 1) that a user inputs or selects by using a user device such as, for example and without limitation, one of clients 121-124 (shown in FIG. 1). Then, control is transferred to step 350 (shown in FIG. 3).

In accordance with one or more embodiments of the present invention, server 101 (shown in FIG. 1) provides a user interface that is well known in the art such as, for example and without limitation, a text box (such as text box 401 shown in FIG. 4A) or menu for the user to input or select one or more object categories. And then server 101 (shown in FIG. 1) provides the one or more objects according to the one or more object categories that are input or selected by the user. In accordance with one or more embodiments of the present invention, server 101 (shown in FIG. 1) provides a user interface that is well known in the art such as, for example and without limitation, a text box (such as text box 402 shown in FIG. 4A) or menu for the user to input or select a quantity (or number) of objects. In accordance with one or more such embodiments, according to the quantity (or number) input or selected by the user, server 101 (shown in FIG. 1) randomly provides a group of objects using data from database 102 (shown in FIG. 1). In accordance with one or more embodiments of the present invention, server 101 provides the one or more objects in a text, picture, audio, or multimedia format that is well known in the art such as, for example and without limitation, plain text, JPEG, WAV, or AVI. In accordance with one or more embodiments of the present invention, server 101 (shown in FIG. 1) provides the one or more objects based on user data stored in database 102 (shown in FIG. 1) such as, for example and without limitation, interests of objects, content type preferences, or past learning performance.

In accordance with one or more embodiments of the present invention, server 101 (shown in FIG. 1) provides a user interface that is well known in the art such as, for example and without limitation, a text box, combo box, or menu for the user to input or select the one or more objects. In accordance with one or more such embodiments, the menu includes a pull-down menu. In accordance with one or more embodiments of the present invention, the menu includes a set of images that the user can click on to select or unselect objects. In accordance with one or more embodiments of the present invention, the menu includes check boxes (such as check box 414 shown in FIG. 4B) or radio buttons for the user to select or unselect objects.

As illustrated in FIG. 4B, in accordance with one or more embodiments of the present invention, server 101 (shown in FIG. 1) provides object menu 41 that includes one or more object options for selection by the user. In accordance with one or more such embodiments, as shown in FIG. 4B, object menu 41 includes a check box, such as check box 414, for selection of an object option that is nearest to it; a checked check box, such as checked check box 415, indicates that an object option that is nearest to it has been selected. In accordance with one or more embodiments of the present invention, object menu 41 includes a text object option such as, for example and without limitation, text object option 411. In accordance with one or more such embodiments, the text object option is in the default language of the client device used by the user or in a language preset according to an input or selection by the user. In accordance with one or more embodiments of the present invention, object menu includes a picture object option such as, for example and without limitation, picture object option 412. In accordance with one or more embodiments of the present invention, object menu 41 includes a multiple-selection check box such as, for example and without limitation, multiple-selection check box 413 for the user to select multiple object options at once.

As illustrated in FIG. 4B, in accordance with one or more embodiments of the present invention, server 101 (shown in FIG. 1) includes an index such as, for example and without limitation, index 431 that is associated with an object option. In accordance with one or more embodiments of the present invention, object options that represent a same concept are associated with a same index. For example, text object option 411 and picture object option 412 are associated with index 431. In accordance with one or more embodiments of the present invention, among different object options that represent the same concept, only one object option is allowed to be selected by the user.

In accordance with one or more embodiments of the present invention, each object option has a unique index, and different object options that represent a same concept have different indices.

Further, in the method shown in FIG. 3, at step 320 (shown in FIG. 3), server 101 (shown in FIG. 1) provides content types to be selected by the user. In accordance with one or more embodiments of the present invention, the content types include a text type. In accordance with one or more embodiments of the present invention, the content types include a picture type. In accordance with one or more embodiments of the present invention, the content types include an audio type. In accordance with one or more embodiments of the present invention, the content types include a multimedia type.

In accordance with one or more embodiments of the present invention, server 101 provides a user interface that is well known in the art such as, for example and without limitation, a combo box or menu for the user to select from the content types. In accordance with one or more such embodiments, the menu includes a pull-down menu. In accordance with one or more embodiments of the present invention, the menu includes a set of images that the user can click on to select or unselect a content type. In accordance with one or more embodiments of the present invention, the menu includes check boxes (such as check box 426 shown in FIG. 4B) or radio buttons for the user to select or unselect content types. Then, control is transferred to step 321 (shown in FIG. 3).

As illustrated in FIG. 4B, in accordance with one or more embodiments of the present invention, server 101 (shown in FIG. 1) provides content type menu 42 that includes content types for selection by the user. In accordance with one or more such embodiments, as shown in FIG. 4B, content type menu 42 includes a check box such as, for example and without limitation, check box 426: (i) for the user to select the content type that vertically aligns with it and (ii) for server 101 (shown in FIG. 1) to provide a content for an object that horizontally aligns with it; a checked check box such as, for example and without limitation, checked check box 427, indicates that a content type that vertically aligns with it has been selected. In accordance with one or more embodiments of the present invention, content type menu 42 includes text type indicator 421, which text type indicator 421 is adapted to indicate a text type as a content type option. In accordance with one or more embodiments of the present invention, content type menu 42 includes picture type indicator 422, which picture type indicator 422 is adapted to indicate a picture type as a content type option. In accordance with one or more embodiments of the present invention, content type menu 42 includes audio type indicator 423, which audio type indicator 423 is adapted to indicate an audio type as a content type option. In accordance with one or more embodiments of the present invention, content type menu 42 includes multimedia type indicator 424, which multimedia type indicator 424 is adapted to indicate a multimedia type as a content type option. In accordance with one or more embodiments of the present invention, content type menu 42 includes a multiple-selection check box such as, for example and without limitation, multiple-selection check box 425 for the user to select a same content type for multiple objects at once.

In the method shown in FIG. 3, at step 321, server 101 (shown in FIG. 1) receives one or more selected content types that are selected by the user. Then, control is transferred to step 350 (shown in FIG. 3).

Further, in the method shown in FIG. 3, at step 330, server 101 (shown in FIG. 1) provides language options to be selected by the user. In accordance with one or more such embodiments, server 101 provides a user interface that is well known in the art such as, for example and without limitation, a menu for the user to select from the language options. In accordance with one or more such embodiments, the menu includes a pull-down menu. In accordance with one or more embodiments of the present invention, the menu includes a set of images that the user can click on to select or unselect a language. In accordance with one or more embodiments of the present invention, the menu includes check boxes or radio buttons (such as radio button 441 shown in FIG. 4C) for the user to select or unselect a language. Then, control is transferred to step 331 (shown in FIG. 3).

As illustrated in FIG. 4C, in accordance with one or more embodiments of the present invention, server 101 (shown in FIG. 1) provides language menu 44 that includes language options for selection by the user. In accordance with one or more such embodiments, as shown in FIG. 4C, language menu 44 includes a radio button such as, for example and without limitation, radio button 441 for the user to select an associated language option; a selected radio button, such as selected radio button 442, indicates that the language that is associated with it has been selected. In accordance with one or more such embodiment, in language menu 44, when a radio button is selected, all other radio buttons will be automatically unselected, so that only one language can be selected.

In the method shown in FIG. 3, at step 331, server 101 (shown in FIG. 1) receives a selected language that is selected by the user. Then, control is transferred to step 350 (shown in FIG. 3).

At step 350 (shown in FIG. 3), server 101 (shown in FIG. 1) provides one or more contents according to the one or more objects given at step 310, the one or more content types received at step 321, and the language received at step 331.

In accordance with one or more embodiments of the present invention, if server 101 (shown in FIG. 1) has: (a) provided or received a text object in Language-X at step 310 (shown in FIG. 3), (b) received a text type as a selected content type at step 321 (shown in FIG. 3), and (c) received Language-X as the selected language at step 331 (shown in FIG. 3), then at step 350 (shown in FIG. 3) server 101 will provide a Language-X-plus text content that includes a synonym, definition, description, detail, reference, or hint of the text object; here Language-X represents a language such as, for example and without limitation, English. For example and without limitation, as illustrated in FIG. 5, English-plus text content 51 includes English description 512 of “Putter”, a text object in English represented by text object option 411 shown in FIG. 4B.

In accordance with one or more embodiments of the present invention, if server 101 (shown in FIG. 1) has: (a) provided or received a text object in Language-X, (b) received a text type as a selected content type, and (c) received Language-Y as the selected language, then at step 350 (shown in FIG. 3) server 101 will provide a Language-Y text content that includes a translation, description, or hint (in Language-Y) of the text object; here Language-X and Language-Y represent two different languages such as, for example and without limitation, English and Chinese. For example and without limitation, as illustrated in FIG. 5, Chinese text content 52 includes Chinese translation 522 of “Putter”, a text object in English represented by text object option 411 shown in FIG. 4B.

In accordance with one or more embodiments of the present invention, if server 101 (shown in FIG. 1) has: (a) provided or received a text object and (b) received a picture type as the selected content type, then at step 350 (shown in FIG. 3) server 101 will provide a picture content that includes a picture, drawing, image, animation, or video recording that is relating to the text object. In accordance with one or more such embodiments, the picture, drawing, image, animation, or video recording shows an illustration, detail, reference, subsystem, super-system, or hint of the text object. For example and without limitation, as illustrated in FIG. 5, picture content 54 includes drawing 542 that shows an illustration of “Putter”, a text object represented by text object option 411 shown in FIG. 4B.

In accordance with one or more embodiments of the present invention, if server 101 (shown in FIG. 1) has: (a) provided or received a text object or picture object, (b) received an audio type as a selected content type, and (c) received Language-X as the selected language, then at step 350 (shown in FIG. 3) server 101 will provide an audio content that includes an audio file with a sound or a narration in Language-X that is relating to the text object or picture object; here Language-X represents a language such as, for example and without limitation, English. For example and without limitation, as illustrated in FIG. 5, audio content 55 includes an audio file embedded in audio icon 552.

In accordance with one or more embodiments of the present invention, if server 101 (shown in FIG. 1) has: (a) provided or received a text object or picture object, (b) received a multimedia type as a selected content type, and (c) received Language-X as the selected language, then at step 350 (shown in FIG. 3) server 101 will provide a multimedia content that includes a combination of at least two of a text in Language-X, an image or video recording, and a sound or narration in Language-X that are relating to the text object or picture object; here Language-X represents a language such as, for example and without limitation, English. For example and without limitation, as illustrated in FIG. 5, multimedia content 56 includes embedded multimedia file 562.

In accordance with one or more embodiments of the present invention, if server 101 (shown in FIG. 1) has: (a) provided or received a picture object, (b) received a text type as a selected content type, and (c) received Language-X as the selected language, then at step 350 (shown in FIG. 3) server 101 will provide a Language-X text content that includes a name, description, or hint (in Language-X) of the picture object; here Language-X represents a language such as, for example and without limitation, English. For example and without limitation, as illustrated in FIG. 5, English text content 57 includes English name 572 of a picture object (“putter”) represented by picture object option 412 shown in FIG. 4B.

In accordance with one or more embodiments of the present invention, if server 101 (shown in FIG. 1) has: (a) provided or received a picture object and (b) received a picture type as a selected content type, then at step 350 (shown in FIG. 3) server 101 will provide a picture-plus content that includes a picture, drawing, image, animation, or video recording that is relating to but different from the picture object. In accordance with one or more such embodiments, the picture, drawing, image, animation, or video recording shows an illustration, detail, reference, subsystem, super-system, or hint that is relating to the picture object. For example and without limitation, as illustrated in FIG. 5, picture-plus content 58 includes drawing 582 that shows an illustration of use of a picture object (“putter”) represented by picture object option 412 shown in FIG. 4B.

In accordance with one or more embodiments of the present invention, if server 101 (shown in FIG. 1) has: (a) provided or received an audio object and (b) received an audio type as a selected content type, then at step 350 (shown in FIG. 3) server 101 will provide an audio-plus content that includes a sound or narration that is relating to but different from the audio object.

In accordance with one or more embodiments of the present invention, if server 101 (shown in FIG. I) has: (a) provided or received a multimedia object and (b) received a multimedia type as a selected content type, then at step 350 (shown in FIG. 3) server 101 will provide an multimedia-plus content that includes a multimedia representation that is relating to but different from the multimedia object.

As further illustrated in FIG. 5, in accordance with one or more embodiments of the present invention, a content provided by server 101 (shown in FIG. 1) includes a content type indicator such as, for example and without limitation, text type indicator 421 in English-plus text content 51, picture type indicator 422 in picture content 54, audio type indicator 423 in audio content 55, multimedia type indicator 424 in multimedia content 56, or picture-plus type indicator in picture-plus content 58. In accordance with one or more embodiments of the present invention, a text content provided by server 101 (shown in FIG. 101) includes a language indicator such as, for example and without limitation, English-plus indicator 511 in English-plus text content 51, Chinese indicator 521 in Chinese text content 52, or English indicator 571 in English text content 57. Further, in accordance with one or more embodiments of the present invention, a text content provided by server 101 (shown in FIG. 101) includes additional language information such as, for example and without limitation, pronunciation 523 in Chinese text content 52. Still further, in accordance with one or more embodiments of the present invention, a content provided by server 101 (shown in FIG. 101) includes an index such as, for example and without limitation, index 431 (shown in FIG. 5) of a selected object such as, for example and without limitation, a “putter” represented by text object option 411 shown in FIG. 4B.

After step 350 (shown in FIG. 3), control is then transferred to step 360 (shown in FIG. 3).

Further, in the method shown in FIG. 3, at step 340, server 101 (shown in FIG. 1) provides one or more game types to be selected by the user. In accordance with one or more such embodiments, server 101 provides a user interface that is well known in the art such as, for example and without limitation, a menu for the user to select from the game types. In accordance with one or more such embodiments, the menu includes a pull-down menu. In accordance with one or more embodiments of the present invention, the menu includes a set of images that the user can click on to select or unselect a game type. In accordance with one or more embodiments of the present invention, the menu includes check boxes or radio buttons (such as radio button 451 shown in FIG. 4D) for the user to select or unselect a game type. Then, control is transferred to step 341 (shown in FIG. 3).

As illustrated in FIG. 4D, in accordance with one or more embodiments of the present invention, server 101 (shown in FIG. 1) provides game type menu 45 that includes game type options for selection by the user. In accordance with one or more such embodiments, as shown in FIG. 4D, language menu 45 includes a radio buttons such as, for example and without limitation, radio button 451 for the user to select an associated game type; a selected radio button, such as selected radio button 452, indicates that the game type that is associated with it has been selected. In accordance with one or more such embodiment, in game type menu 45, when a radio button is selected, all other radio buttons will be automatically unselected, so that only one game type can be selected. In accordance with one or more embodiments of the present invention, the game type options include a multiple choice question game. In accordance with one or more embodiments of the present invention, the game type options include a matching game. In accordance with one or more embodiments of the present invention, the game type options include a memory matching game.

In the method shown in FIG. 3, at step 341, server 101 (shown in FIG. 1) receives a selected game type that is selected by the user. Then, control is transferred to step 342 (shown in FIG. 3).

At step 342 (shown in FIG. 3), in accordance with one or more embodiments of the present invention, server 101 (shown in FIG. 1) determines whether one or more additional contents and/or objects are needed for providing a game that is in accordance with the selected game type received at step 341 (shown in FIG. 3). For example and without limitation, if a multiple choice game is received at step 341, then server 101 (shown in FIG. 1) may need to provide additional contents such as, for example and without limitation, additional picture content 621 or additional text content 622 illustrated in FIG. 6. In accordance with one or more embodiments of the present invention, server 101 (shown in FIG. 1) provides an option for the user to request one or more additional contents and/or objects for making the game more complicated or interesting. In accordance with one or more such embodiments, server 101 provides a user interface for the user to input or select a quantity (or number) of the one or more additional objects and/or contents. If one or more additional contents and/or objects are needed or requested, then control is transferred to step 343 (shown in FIG. 3). If no additional content or object is needed or requested, then control is transferred to step 360 (shown in FIG. 3).

At step 343 (shown in FIG. 3), server 101 (shown in FIG. 1) provides one or more additional contents and/or objects, based on a need of the selected game type identified at step 342 (shown in FIG. 3) and/or a request made by the user at step 342 (shown in FIG. 3). In accordance with one or more such embodiments, server 101 (shown in FIG. 1) randomly provides a group of contents and/or objects using data from database 102 (shown in FIG. 1), according to a predetermined or default quantity (or number) associated with the selected game type or the quantity (or number) input or selected by the user. In accordance with one or more embodiments of the present invention, the one or more additional objects provided by server 101 (shown in FIG. 1) are consistent with a type of the one or more provided or received objects from step 310 (shown in FIG. 3). In accordance with one or more embodiments of the present invention, the one or more additional contents provided by server 101 (shown in FIG. 1) are consistent with a selected content type from step 321 (shown in FIG. 3) In accordance with one or more embodiments of the present invention, server 101 (shown in FIG. 1) provides the one or more contents and/or objects based on user data stored in database 102 (shown in FIG. 1) such as, for example and without limitation, interests of objects, content type preferences, or past learning performance. Then, control is transferred to step 360 (shown in FIG. 3).

At step 360 (shown in FIG. 3), server 101 provides a game that includes the one or more provided or received objects (from step 310 shown in FIG. 3) and provided contents (from step 350 shown in FIG. 3) and, if applicable, the one or more additional contents and/or objects (from step 343 shown in FIG. 3), in accordance with the selected game type (from step 341 shown in FIG. 3). In accordance with one or more embodiments of the present invention, the game includes a multiple choice question. In accordance with one or more embodiments of the present invention, the game includes a matching game. In accordance with one or more embodiments of the present invention, the game includes a memory matching game.

FIG. 6 illustrates multiple choice game 600 that is fabricated in accordance with one or more embodiments of the present invention, assuming server 101 (shown in FIG. 1) has: (a) provided or received an English text object, and (b) received a picture type and a Chinese text type as the selected content types. As shown in FIG. 6, multiple choice game 600 includes question statement 61 and choices 62. As shown in FIG. 6, in accordance with one or more embodiments of the present invention, question statement 61 includes object 611. In accordance with one or more such embodiments, object 611 is represented by text object option 411 (shown in FIG. 4B) and is provided or received by server 101 (shown in FIG. 1) at step 310 (shown in FIG. 3). In accordance with one or more embodiments of the present invention, choices 62 include drawing 542 in a choice, which drawing 542 includes an illustration of object 611. In accordance with one or more embodiments of the present invention, choices 62 include Chinese translation 522 of object 611 in a choice. In accordance with one or more embodiments of the present invention, choice 62 include additional picture 621 and additional Chinese text 622 as choices, which additional picture 621 and additional Chinese text 622 are provided at step 343 (shown in FIG. 3). In accordance with one or more embodiments of the present invention, choice 62 include additional language information such as, for example and without limitation, pronunciation 523 and pronunciation 623. In accordance with one or more embodiments of the present invention, a player can make choices using a user interface that is well known in the art such as, for example and without limitation, a plurality of checkboxes; the player may be the aforementioned user or another person. In accordance with one or more embodiments of the present invention, multiple choice game 600 is implemented using one or more computer programming languages that are well known to one of ordinary skill in the art such as, for example and without limitation, JavaScript.

In accordance with one or more embodiments of the present invention, at step 360 (shown in FIG. 3), server 101 provides a matching game that includes the one or more provided or received objects (from step 310 shown in FIG. 3) and provided contents (from step 350 shown in FIG. 3) and, if applicable, the one or more additional contents and/or objects (from step 343 shown in FIG. 3). In accordance with one or more such embodiments, the matching game is adapted to be played by one or more players over communication network 110. In accordance with one or more embodiments of the present invention, the matching game is adapted to allow different players to take turns making matching attempts. In accordance with one or more embodiments of the present invention, in the matching game, contents are included in content cards that are arranged to form one or more content card rows, and objects are included in object cards that are arranged to form an object card row; a player makes attempts to match object cards with content cards. In accordance with one or more such embodiments, three or more content card rows around an object card row are shown in a three-dimensional card array that can be rotated by the player to show and select cards, in order to make matching attempts.

FIG. 7 illustrates matching game 700 that is fabricated in accordance with one or more embodiments of the present invention, assuming server 101 (shown in FIG. 1) has: (1) provided or received an English text object (at step 310 shown in FIG. 3), and (b) received a picture type and a Chinese text type as the selected content types (at step 321 shown in FIG. 3). As shown in FIG. 7, in accordance with one or more embodiments of the present invention, matching game 700 shows a card array, which card array includes (a) object card row 701 and (b) content card rows 702 and 703 at different sides of the object card row.

As shown in FIG. 7, in accordance with one or more embodiments of the present invention, object card row 701 includes object card 71 and additional object card 74. Object card 71 includes object 611, which object 611 is represented by text object option 411 (shown in FIG. 4B) and is provided or received by server 101 (shown in FIG. 1) at step 310 (shown in FIG. 3). Object card 71 further includes object marker 711 that is adapted to distinguish object card 71 (and object 611) from additional object cards (and additional objects) such as, for example and without limitation, additional object card 74. Additional object card 74 includes an additional object that is provided at step 343.

As shown in FIG. 7, in accordance with one or more embodiments of the present invention, content card rows 702 and 703 include picture card row 702 and Chinese text card row 703. Picture card row 702 includes picture card 72 and additional picture card 75; and Chinese text card row 703 includes Chinese text card 73 and additional Chinese text card 76. Picture card 72 and Chinese text card 73 include drawing 542 and Chinese translation 522, respectively, that are relating to object 611 (shown in FIG. 7) and are provided at step 350 (shown in FIG. 3). Additional picture card 75 and additional Chinese text card include a picture and a Chinese text, respectively, that are relating to the additional object in additional object card 74 and are provided at step 343 (shown in FIG. 3). Picture card 75 and additional picture card 75 include picture type indicator 422 that is adapted to indicate the picture type of picture card row 702. Chinese text card 73 and additional Chinese text card 76 include text type indicator 421 and Chinese indicator 521 that are adapted to indicate the text type and the Chinese language, respectively, of Chinese text card row 703. Chinese text card 73 and additional Chinese text card further include additional language information such as, for example and without limitation, pronunciation 523.

In accordance with one or more embodiments of the present invention, in playing matching game 700, a player can make matching attempts by consecutively clicking on (a) a card in object card row 701 such as, for example and without limitation, object card 71 or additional object card 74, and (b) a card in picture card row 702 or Chinese text card row 703 such as, for example and without limitation, picture card 72, additional picture card 75, Chinese text card 73, or additional Chinese text card 76. As illustrated in FIG. 7, a match indicator such as, for example and without limitation, match indicator 77 connects two related cards when a successful matching attempt is made. In accordance with one or more embodiments of the present invention, matching game 700 includes timer 78 that is adapted to show elapsed time since the player starts a game and stop when the player quits the game or completes all matches. In accordance with one or more embodiments of the present invention, matching game 700 includes counter 79 that is adapted to show an updated number of failed matching attempts. In accordance with one or more embodiments of the present invention, failed matching attempts are recorded in database 102 (shown in FIG. 1).

In accordance with one or more embodiments of the present invention, matching game 700 is implemented using one or more computer programming languages that are well known to one of ordinary skill in the art such as, for example and without limitation, JavaScript. In accordance with one or more embodiments of the present invention, the order of cards in each of object card row 701, picture content row 702, and Chinese text card row 703 is randomized using one or more computational random number generation method such as, for example and without limitation, a pseudo-random number generator algorithm.

In accordance with one or more embodiments of the present invention, at step 360 (shown in FIG. 3), server 101 provides a memory matching game that includes the one or more provided or received objects (from step 310 shown in FIG. 3) and provided contents (from step 350 shown in FIG. 3) and, if applicable, the one or more additional contents and/or objects (from step 343 shown in FIG. 3). In accordance with one or more such embodiments, the memory matching game is adapted to be played by one or more players over communication network 110. In accordance with one or more embodiments of the present invention, the matching game is adapted to allow different players to take turns making matching attempts. In accordance with one or more embodiments of the present invention, the matching game includes: (i) object cards that include the provided/received objects and additional objects and (ii) content cards that include the provided contents and additional contents.

FIGS. 8A-8F illustrate a memory matching game that is fabricated in accordance with one or more embodiments of the present invention, assuming server 101 (shown in FIG. 1) has: (1) provided or received an English text object (at step 310 shown in FIG. 3), and (b) received a picture type and a Chinese text type as the selected content types (at step 321 shown in FIG. 3).

In accordance with one or more embodiments of the present invention, objects and contents are simultaneous shown to show matching relations at beginning of or prior to a session of the memory matching game. As illustrated in FIG. 8A, for example and without limitation, object card 81 and picture card 82 are shown aligning with each other and having same index 431 to show a matching relation: object card 81 includes object 611, and picture card 82 includes drawing 542 that includes an illustration of object 611. As further illustrated in FIG. 8A, for example and without limitation, additional object card 85 and additional picture car 86 are shown aligning with each other and having same index 851 to show a matching relation: additional object card 85 includes additional object 852, and additional picture card 86 includes drawing 862 that includes an illustration of additional object 852.

In accordance with one or more embodiments of the present invention, cards that include a same indicator belong to a same object or content card group and are not to be matched with each other. As illustrated in FIG. 8A, for example and without limitation, object card 81 and additional object card 85 include same text type indicator 421 and English indicator 571; picture card 82 and additional picture card 86 include same picture type indicator 422.

In accordance with one or more embodiments of the present invention, object card 81 (shown in FIG. 8A) includes object marker 711 that is adapted to distinguish object card 81 (and object 611) from additional object cards (and additional objects) such as, for example and without limitation, additional object card 85 (and additional object 852).

In accordance with one or more embodiments of the present invention, the object cards and content cards have homogeneous backsides or covers such as, for example and without limitation, cover 80 illustrated in FIG. 8B. In accordance with one or more embodiments of the present invention, as illustrated in FIG. 8B, the memory matching game includes timer 78 that is adapted to show elapsed time since the player starts a game and stop when the player quits the game or completes all matches. In accordance with one or more embodiments of the present invention, the memory matching game includes counter 79 that is adapted to show an updated number of failed matching attempts.

Positions of the object cards and content cards are randomized under the homogeneous covers for the user to play the memory matching game. For example and without limitation, as illustrated in FIG. 8C, object card 81, additional object card 85, picture card 82, and additional picture card 86 are moved to different positions from their initial positions in FIG. 8A. In accordance with one or more such embodiments, indices such as, for example and without limitation, indices 431 and 851 shown in FIG. 8A are hidden after the positions of the object cards and content cards are randomized, so that the player needs to play the memory game by matching objects and contents, but cannot play by matching indices.

The homogeneous covers (such as, for example and without limitation, cover 80 shown in FIG. 8B) are shown for a player to make matching attempts, while contents and objects are hidden. In accordance with one or more embodiments of the present invention, the player makes a matching attempt by consecutively clicking on two homogeneous covers to show two covered cards. As illustrated in FIG. 8D, for example and without limitation, picture card 82 and additional object card 85 are shown. In accordance with one or more such embodiment, if the two cards that are shown do not match, they will return to be covered after a predetermined time, before the player can proceed with a next matching attempt. In accordance with one or more embodiments of the present invention, if the two cards that are shown do not match, they will return to be covered after each of them are clicked on by the player, before the player can proceed with a next matching attempt. In accordance with one or more embodiments of the present invention, a card that is shown in the matching attempt includes a content type indicator such as, for example and without limitation, picture type indicator 422 or text type indicator 421 shown in FIG. 8D. In accordance with one or more embodiments of the present invention, if applicable, a card that is shown in the matching attempt includes a language indicator such as, for example and without limitation, English indicator 571 (shown in FIG. 8D).

In accordance with one or more embodiments of the present invention, cards disappear once they are successfully matched, as illustrated in FIG. 8E.

FIG. 8F illustrates another session of the memory matching game wherein Chinese text contents are included instead of picture contents shown in FIGS. 8A, 8C, and 8D. In accordance with one or more embodiments of the present invention, as illustrated in FIG. 8F, if applicable, a card that is shown in a matching attempt includes an additional language information such as, for example and without limitation, pronunciation 523.

The embodiments of the present invention described above are exemplary. Many changes and modifications may be made to the disclosure recited above, while remaining within the scope of the invention. The scope of the invention should, therefore, be determined not with reference to the above description, but instead should be determined with reference to the appended claims along with their full scope of equivalents.

What is claimed is:

1. A method for assisting learning an object comprising:
receiving a selected content type that is selected from a plurality of content types;
providing a content that is consistent with the selected content type and comprises information relating to the object; and
providing a game that includes the content and the object.

2. The method of claim 1 further comprising receiving the object, which object is input or selected by a user.

3. The method of claim 1 further comprising receiving a quantity for objects to be learned.

4. The method of claim 1 further comprising receiving a selected language that is selected from a plurality of languages.

5. The method of claim 4 wherein the content comprises information in the selected language.

6. The method of claim 1 wherein the plurality of content types comprises a text type.

7. The method of claim 1 wherein the plurality of content types comprises a picture type.

8. The method of claim 1 wherein the plurality of content types comprises an audio type.

9. The method of claim 1 wherein the plurality of content types comprises a multimedia type.

10. The method of claim 1 further comprising receiving a selected game type that is selected from a plurality of game types wherein the game is consistent with the selected game type.

11. The method of claim 1 further comprising providing an additional object to be included in the game.

12. The method of claim 1 further comprising providing an additional content to be included in the game.

13. The method of claim 1 further comprising providing an indicator that is adapted to indicate one of the content types.

14. The method of claim 1 wherein the game comprises a multiple choice game, wherein the object is included in a question statement and the content is included in a choice.

15. The method of claim 1 wherein the game comprises a matching game that is adapted to allow a player to match the object with the content.

16. The method of claim 15 further comprising providing a marker that is adapted to distinguish the object from other objects.

17. The method of claim 15 further comprising recording failed matching attempts.

18. The method of claim 1 wherein the game comprises a matching game is adapted to allow a player to match the object with a plurality of contents.

19. The method of claim 1 wherein the game comprises a memory matching game that allows a player to match the object and the content.

20. The method of claim 19 further comprising simultaneously showing the object and the content at beginning of or prior to the memory matching game.

21. The method of claim 19 wherein the content includes a content type indicator when it is shown in a matching attempt.
